(19) United States
(12) Patent Application Publication
(10) Pub. No.: US 2004/0105609 A1
(43) Pub. Date: Jun. 3, 2004

(54) Optoelectronic signal transmission semi-conductor element and method for producing a semi-conductor element of said type

(76) Inventor: Bernhard Stegmuller, Augsburg (DE)

Correspondence Address: Jeffrey R Stone, Briggs & Morgan, 2400 IDS Center, Minneapolis, MN, 55402, US

(21) Appl. No.: 10/470,447

(22) PCT Filed: Jan. 25, 2002
(86) PCT No.: PCT/DE02/00258

(30) Foreign Application Priority Data
Feb. 1, 2001 (DE) 101 04 563.8

(51) Int. Cl. G02B 6/12

(52) U.S. Cl. 385/14

(57) ABSTRACT

An apparatus and method for producing a semiconductor element having an integrated semiconductor structure. An optoelectronic transmitter and an optoelectronic receiver are mounted on the semiconductor structure. The optoelectronic transmitter and the optoelectronic receiver are set up for optoelectronic signal transmission within the semiconductor element, are optically coupled to one another and are optically decoupled from their environment by an optical filter element.

The invention relates to a semiconductor element and to a method for producing such a semiconductor element.

According to the prior art, an electrical method or an electronic method is used for signal transmission in an integrated circuit on a semiconductor substrate. However, these methods limit the data rate with which signals can be transmitted from one component to another component within the integrated circuit on a semiconductor substrate. If signals are transmitted with a narrow carrier bandwidth of less than 1 GHz, a maximum data rate of only up to 10 Gbit/s can therefore be achieved. Furthermore, if the carrier bandwidth is becoming wider, the maximum data rate for signal transmission is even narrower.

In addition, electrical methods or electronic methods for signal transmission in an integrated circuit limit the capability for miniaturization of the integrated circuit owing to the interconnects which are required in this case. Furthermore, the interconnects result in a large amount of energy being consumed, owing to their electrical resistance.

A transmission system for conference rooms is known from the prior art, for example from [1], in which audio and data signals are transmitted by optical means between a control center and a remote subscriber.

Furthermore, for example from [2], [3], [4] and [5] optocouplers are known from the prior art, which are provided for electrical decoupling between two electrical circuits. In this case, a layer which is optically transparent but is electrically insulating is used between a light transmitter and a light receiver, and ensures suitable optical coupling, and electrical isolation at the same time. The light receiver and light transmitter are normally mounted one above the other on a substrate.

Furthermore, an optical integrated circuit is known from the prior art, for example from [6], in which a laser diode emits laser light, whose beam path is deflected by means of a mirror, and is then detected by a photodiode. The laser diode and the photodiode are arranged alongside one another on a semiconductor substrate.

An optoelectronic element in which a laser emitter and an optical detector are arranged alongside one another and at a certain distance apart from one another above a waveguide on a semiconductor substrate is known from [7].

An optical connecting unit for use in a data processing apparatus is known from [8]. This optical connecting unit has two or more optical connecting elements in addition to a light source and a light-receiving element. These optical connecting elements have the task of supplying the light which is emitted from the light source in a suitable manner to the light-receiving element.

The optical apparatuses which are disclosed in the prior art are subject to the problem, however, that the optical detectors which are used in the optical apparatuses can also detect light which, for example, originates from another light source. This can result in a considerable reduction in the maximum data rate which can be transmitted in these optical apparatuses.

The problems described above are becoming increasingly important for very large scale integrated circuits (VLSI circuits).

The invention is therefore based on the problem of specifying a semiconductor element and a method for producing a semiconductor element, by means of which a higher maximum data rate can be achieved for signal transmission, with less consumption of energy and space and despite a wider carrier bandwidth.

The problem is solved by a semiconductor element and by a method for producing such a semiconductor element having the features as claimed in the independent patent claims.

A semiconductor element has an integrated semiconductor structure. An optoelectronic transmitter and an optoelectronic receiver are mounted on the integrated semiconductor structure. The optoelectronic transmitter and the optoelectronic receiver are set up for optoelectronic signal transmission within the semiconductor element, are optically coupled to one another and are optically decoupled from their environment by means of an optical filter element.

In a method for producing a semiconductor element with optoelectronic signal transmission, an optoelectronic transmitter and an optoelectronic receiver are mounted on an integrated semiconductor structure. Furthermore, a Bragg structure which is in the form of an optical filter element is mounted on the integrated semiconductor structure, on all sides apart from sides which face one another on the optoelectronic transmitter and of the optoelectronic receiver.

One advantage of the invention is that the semiconductor element according to the invention makes it possible to achieve a maximum data rate of more than 10 Gbit/s with a wide carrier bandwidth for signal transmission. This high data rate is made possible in particular by optoelectronic transducers, specifically the optoelectronic transmitter and the optoelectronic receiver (for example a laser diode transmitter and a photodiode receiver) which can convert signals at a data rate of more than 10 Gbit/s and, in addition to this, require only a small amount of space, with a maximum of 20×5 μm², for which reason these transducers are also referred to as microtransducers. These microtransducers also accordingly have small electrical contacts, which are likewise suitable for the high data rates. Owing to their power, microtransducers may be separated from one another by a few centimeters, for which reason the invention is intended specifically for use in very large scale integrated circuits.

A further advantage of the semiconductor element according to the invention is that the amount of space required on the semiconductor element is reduced, since there is no longer any need for electrical connections between two or more components for signal transmission between them. In principle, optical signal transmission can also take place in air. Furthermore, it is possible in the case of optical signal transmission for two or more signal transmission paths to cross within a plane without the process adversely affecting the transmitted signals. The method according to the invention for producing such a semiconductor element thus reduces the production effort for semiconductor elements, since fewer crossing-free electrical connections are required in the various grown and etched layers. This considerably reduces the design effort, and hence the production effort, as well as the production costs.

The optical filter element provided in the invention is also advantageous. This makes it possible to minimize disturbing influences on the optoelectronic transducers. Furthermore, skilful arrangement of the optical filter element makes it possible to position two or more optoelectronic transducers very close to one another without any mutual influence. The relevant space requirement on the semiconductor substrate can thus be minimized while, nevertheless, signal transmission remains ensured between two optoelectronic transducers. In consequence, the optical filter element that is provided has an isolating effect for the associated transducer with respect to optical energy which has not been transmitted by the optoelectronic transmitter which is associated with this transducer. An optical filter element that is used in the semiconductor element according to the invention typically has a thickness of up to 5 μm.

Finally, another advantage is that optical signal transmission on the semiconductor element results in less heat being emitted as a result of electrical resistance which resists any current flow in electrical interconnects, so that the semiconductor element can be cooled more easily than in the case of conventional semiconductor elements. Furthermore, optical signal transmission reduces the energy consumption in comparison to electrical signal transmission, due to the reduced electrical resistance and hence the reduced heat that is emitted.

In one preferred development of the semiconductor element according to the invention, an optical filter element can also be provided between the optoelectronic transmitter and the optoelectronic receiver. This allows, for example, better decoupling to be achieved between the optoelectronic transmitter and the signal transmission path. This makes it possible to very largely avoid any influence from disturbance reaction effects on the optoelectronic transmitter. In contrast to this, the optoelectronic receiver should be optically coupled as well as possible to the signal transmission path. In consequence, optical reflections at the input of the optoelectronic receiver, for example due to the use of an optical filter element directly upstream of the input of the optoelectronic receiver, should be avoided.

The optical filter element that is used preferably has at least one essentially completely reflective boundary surface. This means that the boundary surface has a reflection coefficient of virtually 100% for any optical radiation which would penetrate into one of the two optoelectronic transducers accidentally without an optical filter element. In this context, an essentially completely reflective boundary surface means a boundary surface between a first medium in which the optical radiation is reflected back and which has a first refractive index n₁, and a second medium with a second refractive index n₂, with the ratio of the two refractive indices n₁/n₂ essentially not being in unity. The use of the optical filter element thus makes it possible to avoid any adverse effect on the production or the reception of the signals to be transmitted.

A multidimensional Bragg structure, for example a photonic crystal, is preferably used as the essentially completely reflective boundary surface. Multidimensional Bragg structures are periodic structures and have the advantage that they can be produced quite specifically for their filter effect, for example epitaxially or monolithically.

In one preferred development of the semiconductor element according to the invention, an optoelectronic modulator is provided between the optoelectronic transmitter and the optoelectronic receiver.

In a further preferred development of the semiconductor element according to the invention, an optoelectronic amplifier is provided between the optoelectronic transmitter and the optoelectronic receiver.

A waveguide, which may be either a waveguide structure or a photonic crystal, can preferably be provided for signal transmission between the optoelectronic transmitter and the optoelectronic receiver. The waveguide may be in the form of a straight line or else may be curved in any desired shape, and all that is necessary in this case is to ensure that signals which are emitted from the optoelectronic transmitter can be received by the optoelectronic receiver.

The semiconductor element according to the invention is preferably set up such that at least one of the following components has a semiconductor material: the waveguide, the Bragg structure, the optoelectronic transmitter, the optoelectronic receiver, the optoelectronic modulator, the optoelectronic amplifier.

The semiconductor material is preferably a III-V semiconductor. Alternatively, the semiconductor material may also, however, be a II-VI semiconductor. Furthermore, at least one of the components mentioned above could also have a III-V semiconductor, while at least one further one of the components mentioned above could have a II-VI semiconductor. Furthermore, the semiconductor material may also have a IV semiconductor, for example silicon. The waveguide and/or the filter element may also have a different electrooptically passive material, however.

In one preferred development of the semiconductor element according to the invention, the optoelectronic transmitter is in the form of a laser diode, the optoelectronic receiver is in the form of a photodiode, and the optical filter element is in the form of a photonic crystal. An electro-absorption modulator (EAM) can be provided as the optoelectronic modulator. A laser structure with induced emission could also be used as the optoelectronic amplifier. Widely differing combinations of optoelectronically active components may, of course, also be used for the optoelectronic transducers.

In the method according to the invention, a Bragg structure which is in the form of an optical filter element is mounted on the integrated semiconductor structure, preferably between the optoelectronic transmitter and the optoelectronic receiver.

In the method according to the invention, an optoelectronic modulator is preferably mounted on the integrated semiconductor structure, between the optoelectronic transmitter and the optoelectronic receiver.

In addition or as an alternative to the optoelectronic modulator, an optoelectronic amplifier can also be mounted on the integrated semiconductor structure.

Furthermore, in one preferred refinement of the method according to the invention, a waveguide can be mounted on the integrated semiconductor structure, and this waveguide can transmit an optical signal, which is emitted by the optoelectronic transmitter, to the optoelectronic receiver.

Exemplary embodiments of the invention will be explained in more detail in the following text and are illustrated in the figures. In this case, identical reference symbols denote identical components.

In the figures:

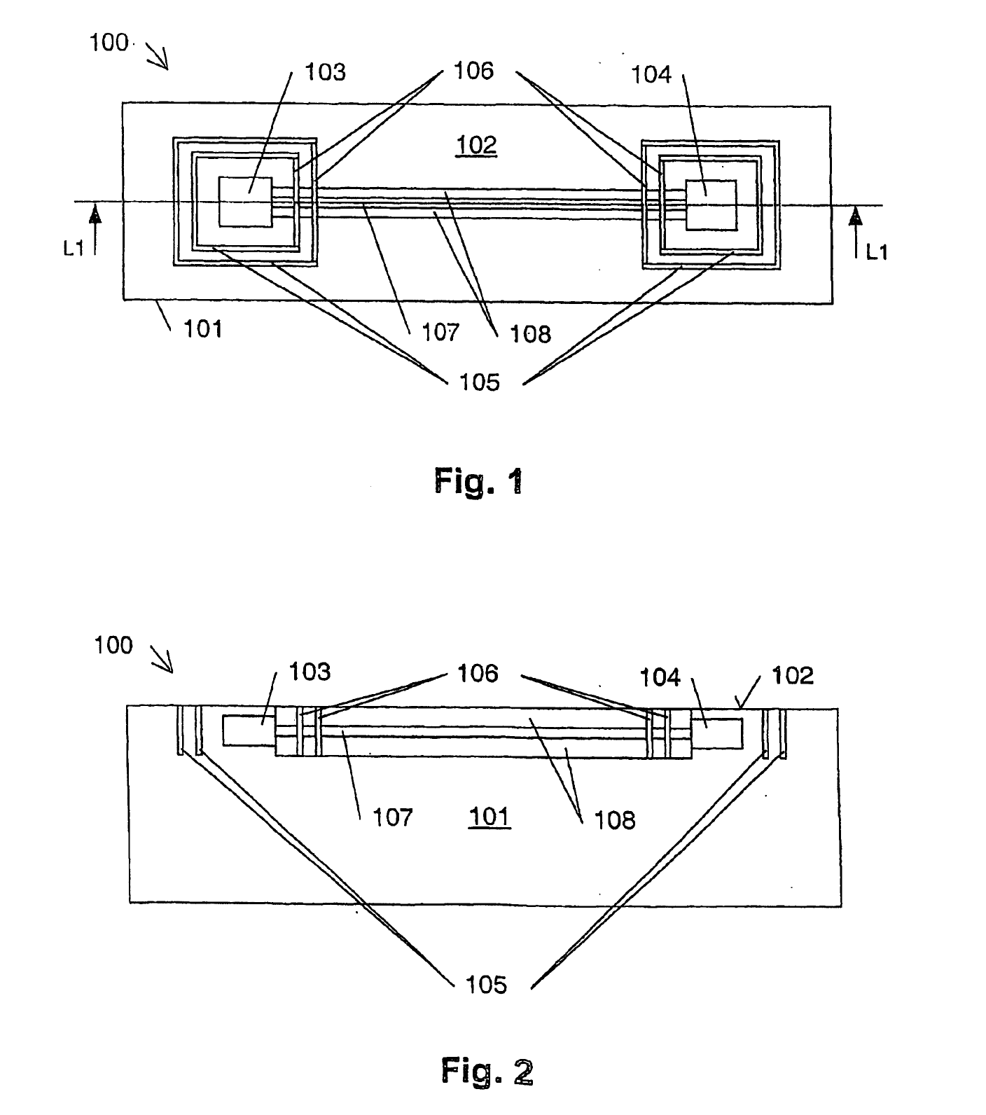

FIG. 1 shows a plan view of a semiconductor element according to a first exemplary embodiment of the invention;

FIG. 2 shows a longitudinal section through the semiconductor element shown in FIG. 1, along the section line L1-L1;

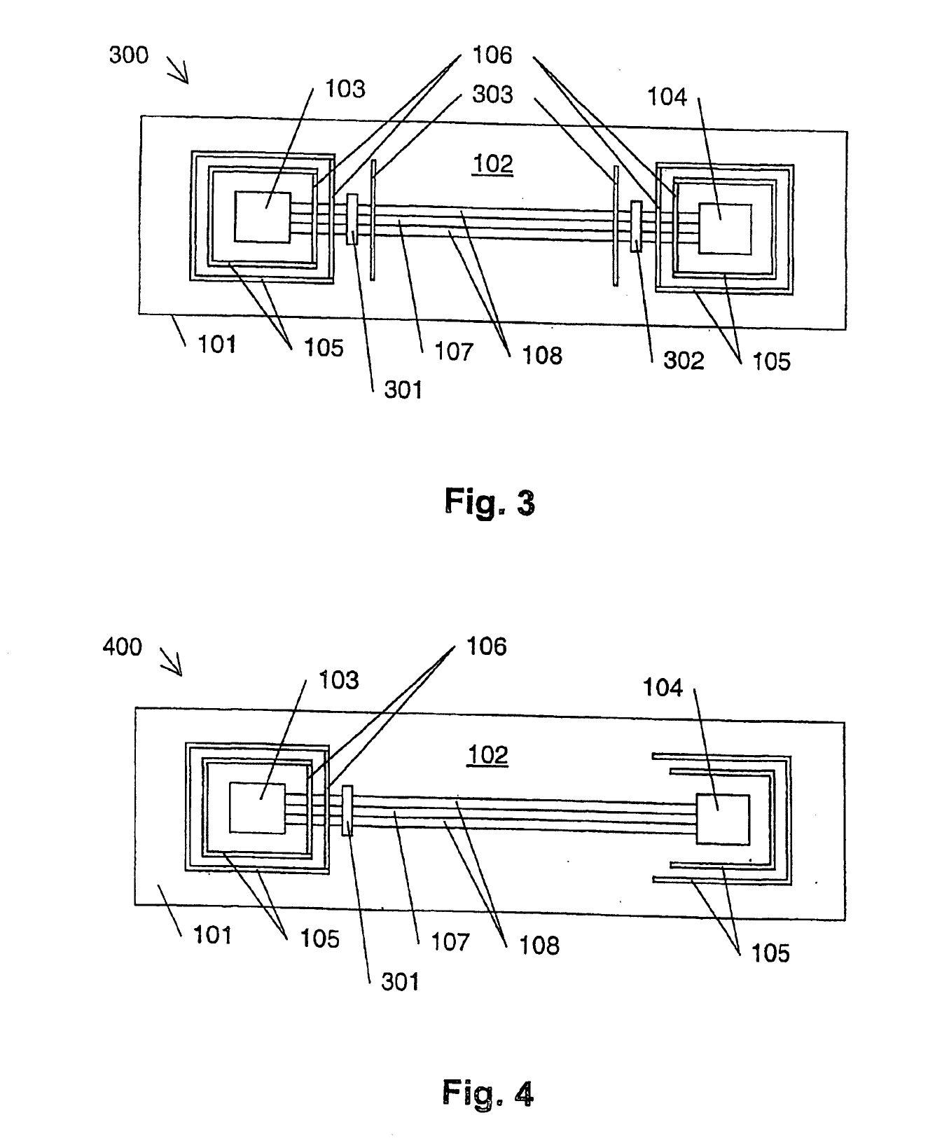

FIG. 3 shows a plan view of a semiconductor element according to a second exemplary embodiment of the invention;

FIG. 4 shows a plan view of a semiconductor element according to a third exemplary embodiment of the invention; and

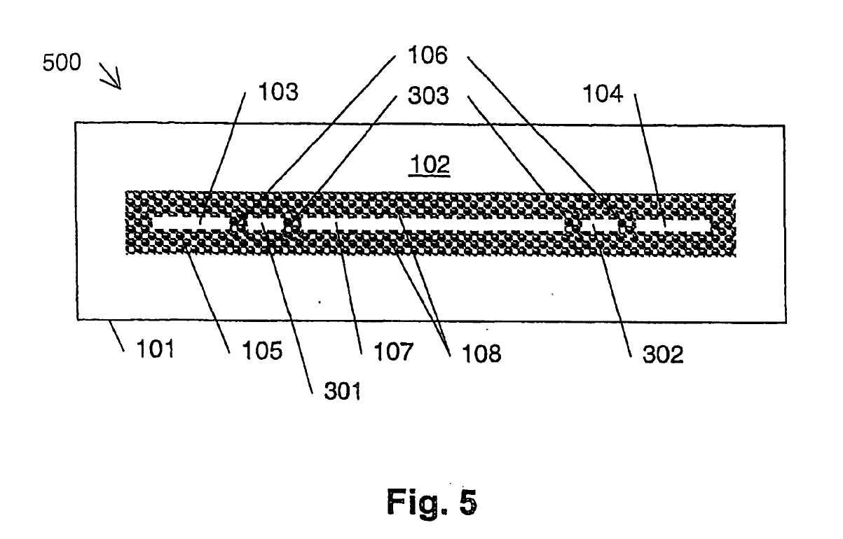

FIG. 5 shows a plan view of a semiconductor element according to a fourth exemplary embodiment of the invention.

FIG. 1 shows a plan view of a semiconductor element 100 according to a first exemplary embodiment of the invention. The semiconductor element 100 has an integrated semiconductor structure on a substrate surface 102 of a substrate 101. In this exemplary embodiment, a laser diode which is in the form of an optoelectronic transmitter 103 and a photodiode which is in the form of an optoelectronic receiver 104 are provided in the substrate 101 and are aligned with respect to one another such that light which is emitted from the optoelectronic transmitter 103 can be detected by the optoelectronic receiver 104.

Both the optoelectronic transmitter 103 and the optoelectronic receiver 104 are optically isolated by first optical filter elements 105 against adverse effects from optical energy which does not originate from the optoelectronic transmitter 103. The first optical filter elements 105 thus ensure that the optoelectronic transducers 103 and 104 are decoupled from their environment, while the optoelectronic transducers 103 and 104 are nevertheless optically coupled to one another.

In order to avoid disturbance reaction effects, the optoelectronic transducers 103 and 104 are additionally decoupled from one another by second optical filter elements 106. In this exemplary embodiment, provision is made for both the optoelectronic transmitter 103 and the optoelectronic receiver 104 to be protected by the second optical filter elements 106 against undesirable reflections and resonances. Protection is in this case predominantly required for the optoelectronic transmitter 103, so that there is no need for the second optical filter elements 106 at the input of the optoelectronic receiver 104 in other exemplary embodiments.

The first optical filter elements 105 and the second optical filter elements 106 may, as shown, be arranged at a specific distance from the optoelectronic transducers 103 and 104. However, it is also possible not to provide any separation between the optical filter elements 105 and 106 and the optoelectronic transducers 103 and 104. This means that the optical elements 105 and 106 may be in the form of boundary surfaces of the optoelectronic transducers 103 and 104.

The optical filter elements 105 and 106 are designed to operate such that optical energy from a first direction is totally reflected on one surface of the optical filter elements 105 and 106, while optical energy from a second direction, which is in the opposite direction to the first direction, is transmitted without any impediment through the optical filter elements 105 and 106. However, optical energy can also be filtered independently of or as a function of the incidence direction on the optical filter elements 105 and 106. In this context, the expression filtering of optical energy means, for example, the selection of preferred wavelengths from a spectrum and/or the reduction in the intensity of the transmitted spectrum.

In this exemplary embodiment, quasi-one-dimensional photonic crystals in the form of Bragg structures are used as the optical filter elements 105 and 106. The Bragg structures provide a specific probability of photons being able to tunnel through the Bragg structures, so that total reflection of optical energy of the Bragg structures is not possible. The optical filter elements 105 and 106 are therefore provided in such a way that two Bragg structures are always arranged side by side.

For signal transmission between the optoelectronic transducers 103 and 104, a waveguide 107 surrounded by a waveguide casing 108 is provided in the substrate 101. The waveguide 107 ensures that the optical energy flows between the optoelectronic transmitter 103 and the associated optoelectronic receiver 104.

II-VI, III-V, or IV-IV semiconductor materials, for example, may be used as the material for the substrate 101, for the optoelectronic transducers 103 and 104, for the optical filter elements 105 and 106, for the waveguide 107 and for the waveguide casing 108 of the integrated semiconductor structure of the semiconductor element 100. In this case, all that should be borne in mind is that:

The material which is chosen for the optoelectronic transducers 103 and 104 must be electrooptically active.

The material which is chosen for the optical filter elements 105 and 106 must have the desired optical filter characteristics.

The material which is chosen for the waveguide 107 must be able to transmit the light spectrum which is emitted from the optoelectronic transmitter 103.

The refractive index of the material which is chosen for the waveguide casing 108 must be matched to the waveguide 107 such that the light spectrum which is emitted from the optoelectronic transmitter 103 is totally reflected on the boundary surface between the waveguide 107 and the waveguide casing 108.

The semiconductor element 100 can be produced using conventional semiconductor production methods. These include, for example, etching, diffusion, doping, epitaxy, implantation and lithography.

The optoelectronic transducers 103 and 104, the optical filter elements 105 and 106 and the waveguide 107 with the waveguide casing 108 may be integrated in the substrate 101 or else may be mounted on the substrate surface 102 of a wafer such that they at least partially project out of the wafer.

In order to illustrate the arrangement, FIG. 2 shows a longitudinal section through the semiconductor element 100 shown in FIG. 1, along the section line L1-L1. This illustration clearly shows that the first optical filter elements 105 surround the optoelectronic transducers 103 and 104 only in a quasi-two-dimensional arrangement in this exemplary embodiment. This means that the first optical filter elements 105 allow optical isolation primarily in directions parallel to the substrate surface 102.

In other exemplary embodiments, optical isolation can also be provided for the optoelectronic transducers 103 and 104 in such a way that the first optical filter elements 105 surround the optoelectronic transducers 103 and 104 in the form of a cage, that is to say first optical filter elements 105 are also provided on those sides of the optoelectronic transducers 103 and 104 which face and/or are averted from the substrate surface 102. This is particularly advantageous when the optoelectronic transducers 103 and 104 are mounted on the substrate surface 102 and neither a waveguide 107 nor a waveguide casing 108 is provided for signal transmission between the optoelectronic transducers 103 and 104, so that, for example, the signals must be transmitted in air.

FIG. 3 shows a plan view of a semiconductor element 300 according to a second exemplary embodiment of the invention. The components which have already been described in FIG. 1 and FIG. 2 will not be described once again here. In contrast to the semiconductor element 100, an optoelectronic modulator 301 and an optoelectronic amplifier 302 are also integrated in the semiconductor element 300, between the optoelectronic transducers 103 and 104.

The optoelectronic modulator 301 is used for modulation of the light which has been emitted from the optoelectronic transducer 103, and is therefore positioned at the output of the optoelectronic transmitter 103. In order to protect the optoelectronic modulator 301 against disturbance reaction effects in a similar manner, a further optical filter element 303 is provided between the waveguide 107 and the optoelectronic modulator 301.

The optoelectronic amplifier 302 is used for amplification of the light which is transmitted by the waveguide 107, before this light is detected by the optoelectronic receiver 104. In this exemplary embodiment, the optoelectronic amplifier 302 is also protected by a further optical filter element 303 against being adversely affected by optical energy which does not originate from the optoelectronic transmitter 103.

FIG. 4 shows a plan view of a semiconductor element 400 according to a third exemplary embodiment of the invention. The semiconductor element 400 in this exemplary embodiment differs from the semiconductor element 300 in that second optical filter elements 106 are provided only between the optoelectronic transmitter 103 and the optoelectronic modulator 301. Protection against disturbance reaction effects is thus provided exclusively for the optoelectronic transmitter 103.

In this exemplary embodiment, there is deliberately no separate protection for the optoelectronic receiver 104 against optical energy which does not originate from the optoelectronic transmitter 103. This at the same time avoids accidental filtering of light which has been emitted from the optoelectronic transmitter 103 and has been modulated by the optoelectronic modulator 301. In comparison to the semiconductor element 300, this improves the detection sensitivity and increases the data rate of the overall semiconductor element 400.

Finally, FIG. 5 shows a plan view of a semiconductor element 500 according to a fourth exemplary embodiment of the invention. The special feature of this semiconductor element 500 in comparison to the already described semiconductor elements is that all the optical filter elements 105 and 106 as well as the waveguide casing 108 are formed by Bragg structures (quasi-two-dimensional photonic crystals) which are integrated in the substrate 101.

A DBR laser diode (DBR=distributed Bragg reflector) or a DFB laser diode (DFB=distributed feedback reflector) is used as the optoelectronic transmitter 103 and is aligned with the optoelectronic receiver 104 by means of the waveguide 107. The Bragg structures within the semiconductor element 500 have different configurations depending on the object (for example filtering and waveguidance). In this case, any desired combinations of DBR structures (quasi-one-dimensional photonic crystals) and DFB structures (quasi-two-dimensional photonic crystals) may also be used.

In this illustration, the waves are guided by the waveguide 107 in a straight line between the two optoelectronic transducers 103 and 104. However, it is also possible to use a waveguide 107 which is curved in any desired shape.

1. A semiconductor element (100) having an integrated semiconductor structure,
in which an optoelectronic transmitter (103) is mounted on the integrated semiconductor structure,
in which an optoelectronic receiver (104) is also mounted on the integrated semiconductor structure,
in which the optoelectronic transmitter (103) and the optoelectronic receiver (104) are set up for optoelectronic signal transmission within the semiconductor element (100), and
in which the optoelectronic transmitter (103) and the optoelectronic receiver (104) are optically coupled to one another, and are optically decoupled from their environment by means of an optical filter element (105).
in which the optical filter element (105) is designed in such a way that optical energy in a first direction, directed from the environment to the optoelectronic transmitter (103) or to the optoelectronic receiver (104), is totally reflected on one surface of the optical filter element (105), while optical energy from a second direction, which is in the opposite direction to the first direction, is transmitted through the optical filter element (105) without any impediment.

2. The semiconductor element (100) as claimed in claim 1, in which an optical filter element (106) is provided between the optoelectronic transmitter (103) and the optoelectronic receiver (104).

3. The semiconductor element (100) as claimed in claim 1 or 2, in which the optical filter element (105, 106) has at least one essentially completely reflective boundary surface.

4. The semiconductor element (100) as claimed in claim 3, in which the essentially completely reflective boundary surface is a multidimensional Bragg structure.

5. The semiconductor element (100) as claimed in one of the preceding claims, in which an optoelectronic modulator (301) is provided between the optoelectronic transmitter (103) and the optoelectronic receiver (104).

6. The semiconductor element (100) as claimed in one-of the preceding claims, in which an optoelectronic amplifier (302) is provided between the optoelectronic transmitter (103) and the optoelectronic receiver (104).

7. The semiconductor element (100) as claimed in one of the preceding claims, in which a waveguide (107) is provided between the optoelectronic transmitter (103) and the optoelectronic receiver (104).

8. The semiconductor element (100) as claimed in claim 7, in which the waveguide (107) is a waveguide structure or a photonic crystal.

9. The semiconductor element (100) as claimed in one of the preceding claims, in which at least one of the following components has a semiconductor material: the waveguide (107), the Bragg structure, the optoelectronic transmitter (103), the optoelectronic receiver (104), the optoelectronic modulator (301), the optoelectronic amplifier (302).

10. The semiconductor element (100) as claimed in claim 9, in which a III-V semiconductor is used as the semiconductor material.

11. The semiconductor element (100) as claimed in claim 9, in which a II-VI semiconductor is used as the semiconductor material.

12. The semiconductor element (100) as claimed in one of the preceding claims,
in which the optoelectronic transmitter (103) is a laser diode,
in which the optoelectronic receiver (104) is a photodiode, and
in which the optical filter element (105, 106) is a photonic crystal.

13. A method for producing a semiconductor element (100), in which an optoelectronic transmitter (103) is mounted on an integrated semiconductor structure,
in which an optoelectronic receiver (104) is also mounted on the integrated semiconductor structure, and
in which a Bragg structure which is in the form of an optical filter element (105) is mounted on the integrated semiconductor structure, on all sides except on mutually facing sides of the optoelectronic transmitter (103) and of the optoelectronic receiver (104),
in which the optical filter element (105) is designed in such a way that optical energy in a first direction, directed from the environment to the optoelectronic transmitter (103) or to the optoelectronic receiver (104), is totally reflected on one surface of the optical filter element (105), while optical energy from a second direction, which is in the opposite direction to the first direction, is transmitted through the optical filter element (105) without any impediment.

14. The method as claimed in claim 13,
in which a Bragg structure which is in the form of an optical filter element (106) is mounted on the integrated semiconductor structure, between the optoelectronic transmitter (103) and the optoelectronic receiver (104).

15. The method as claimed in one of claims 13 or 14, in which an optoelectronic modulator (301) is mounted on the integrated semiconductor structure between the optoelectronic transmitter (103) and the optoelectronic receiver (104).

16. The method as claimed in one of claims 13 to 15, in which an optoelectronic amplifier (302) is mounted on the integrated semiconductor structure between the optoelectronic transmitter (103) and the optoelectronic receiver (104).

17. The method as claimed in one of claims 13 to 16, in which a waveguide (107) is mounted on the integrated semiconductor structure, between the optoelectronic transmitter (103) and the optoelectronic receiver (104), and can transmit an optical signal from the optoelectronic transmitter (103) to the optoelectronic receiver (104).
